(19) United States
(12) Patent Application Publication
(10) Pub. No.: US 2010/0299153 A1
(43) Pub. Date: Nov. 25, 2010

(54) SYSTEM, METHOD AND PROGRAM FOR DETERMINING COMPLIANCE WITH A SERVICE LEVEL AGREEMENT

(75) Inventors: Richard S. Curtis, Ft. Collins, CO (US); Paul Kontogiorgis, Longmont, CO (US); Patrick McCarthy, Longmont, CO (US); Srinivas Babu Tummalapcnta, Broomfield, CO (US)

Correspondence Address: IBM CORPORATION, IPLAW SHCB/40-3, 1701 NORTH STREET, ENDICOTT, NY, 13760, US

(73) Assignee: INTERNATIONAL BUSINESS MACHINES CORPORATION, Armonk, NY (US)

(21) Appl. No.: 12/785,878

(22) Filed: May 24, 2010

Related U.S. Application Data
(63) Continuation of application No. 11/107,294, filed on Apr. 15, 2005, now abandoned.

(51) Int. Cl. G06Q 99/00; G06F 17/30

(52) U.S. Cl. 705/1.1; 707/769; 707/E17.014

(57) ABSTRACT

System, method and program product for monitoring a computer program or database maintained by a service provider for a customer. A multiplicity of failures of the computer program or data base during a reporting interval are identified. The times of the multiplicity of failures are compared to one or more scheduled maintenance windows. A determination is made that at least one of the multiplicity of failures occurred during the one or more scheduled maintenance windows. A determination is also made that the customer was responsible for at least another one of the multiplicity of failures. A determination is made that the service provider was responsible for a plurality of the failures not including the at least one failure occurring during the one or more scheduled maintenance windows and the at least another one failure for which the customer was responsible. A determination is made whether the service provider complied with a service level agreement based on the plurality of the outages. This may be based on a percent time each reporting interval that the computer program had failed based on durations of the plurality of failures. The computer program may need information from another computer program or other database to function normally. If this other computer program or other database failed during the reporting interval, and the customer was responsible for the failure of the other computer program or other database, the service provider is not charged for the failure of the first said computer program. A determination is made as to a monetary cost to a business of the customer for the plurality of said failures.

### CROSS REFERENCE TO RELATED APPLICATION

This application is a Continuation Application of U.S. application Ser. No. 11/107,294 filed on Apr. 15, 2005.

### BACKGROUND

The present invention relates generally to computers, and more particularly to determining compliance of a computer program or database with a service level agreement.

A service level agreement (“SLA”) typically specifies a target level of operability (or availability) of computer hardware, computer programs (typically applications) and databases. If the computer service provider does not meet the target level of operability and is at fault, then the service provider may be penalized under the SLA. It is important, especially to the customer, to know the actual level of operability of the computer programs and the entity responsible for outages, to determine compliance by the computer service provider with the SLA.

It was known for the customer to report to a computer service provider a complete failure or slow operation of a computer program or the associated computer system, when the customer notices the problem or a fault management system discovers the problem and sends an event notification. For example, if the customer cannot access or use a business application, the customer may call a help desk to report the outage or problem, and request correction. In response, the help desk person fills out an outage or problem ticket using a problem and change management system. The help desk person will also report to the problem and change management system when the application is subsequently restored, i.e. once again becomes fully operable. Every month, the problem and change management system gathers information indicating the duration of all outages during the month and the percent down time. Then, the problem and change management system forwards this information to a reporting system. While this will inform the customer of the level of availability of the computer program, some of the problems are the fault of the customer.

It was also known to measure availability of servers (i.e. operability of and access to the servers) by periodically pinging the servers to determine if they respond, and then calculating down time and percent down time every month. When the server is unavailable, an event is generated, and in response, a problem (or outage) ticket is generated. If the unavailability is the customer's fault, then the unavailability is not charged to the service provider for purposes of determining compliance with an SLA. For example, if the customer is responsible for a network to connect to the server, and the network fails, then this unavailability of the server is not charged to the service provider.

There are many known program tools to monitor availability and performance of applications and databases, and automatically report when the application or database is down or operating slowly. Such program tools include Tivoli Monitoring for Databases program, Tivoli Monitoring for Transaction Performance program, Omegamon XE monitoring tool and CYANEA product sets.

An object of the present invention is to accurately measure compliance of a computer program with an SLA.

### SUMMARY

The present invention resides in a system, method and program product for monitoring a computer program or database maintained by a service provider for a customer. A multiplicity of failures of the computer program or data base during a reporting interval are identified. The times of the multiplicity of failures are compared to one or more scheduled maintenance windows. A determination is made that at least one of the multiplicity of failures occurred during the one or more scheduled maintenance windows. A determination is also made that the customer was responsible for at least another one of the multiplicity of failures. A determination is made that the service provider was responsible for a plurality of the failures not including the at least one failure occurring during the one or more scheduled maintenance windows and the at least another one failure for which the customer was responsible. A determination is made whether the service provider complied with a service level agreement based on the plurality of the outages. This may be based on a percent time each reporting interval that the computer program had failed based on durations of the plurality of failures.

The computer program may need information from another computer program or other database to function normally. If this other computer program or other database failed during the reporting interval, and the customer was responsible for the failure of the other computer program or other database, the service provider is not charged for the failure of the first said computer program. This other computer program may be a database management program, in which case, the information is data from a database managed by the database management program.

In accordance with an optional feature of the present invention, a determination is made as to a monetary cost to a business of the customer for the plurality of said failures.

### BRIEF DESCRIPTION OF THE FIGURES

FIG. 1 is a block diagram of a distributed computer system which includes the present invention.

FIG. 2 is a flow chart of a known software monitoring program tool within each server of FIG. 1.

FIG. 3 is a flow chart of an event management program within an event management console of FIG. 1.

FIGS. 4(A) and 4(B) form a flow chart of a problem and change management program within a problem and change management computer of FIG. 1.

FIG. 5 is a flow chart of a reporting program within a reporting computer of FIG. 1.

### DETAILED DESCRIPTION OF THE PREFERRED EMBODIMENTS

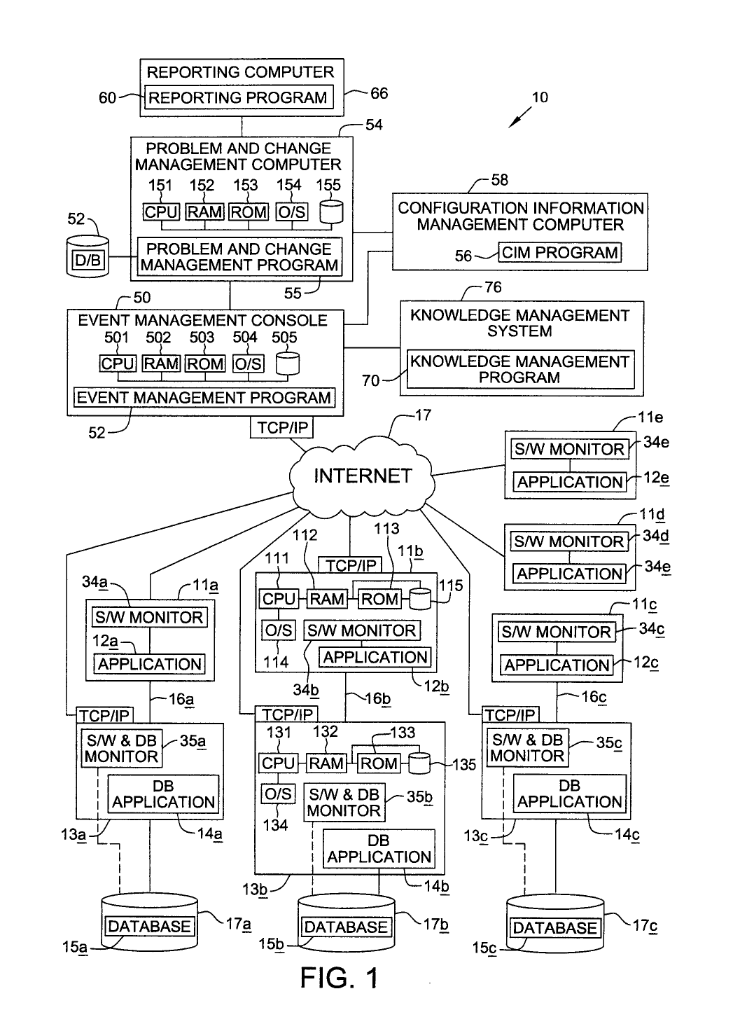

The present invention will now be described in detail with reference to the figures. FIG. 1 illustrates a distributed computer system 10 which includes the present invention. Distributed computer system 10 comprises servers 11a,b,c,d,e with respective known applications 12a,b,c,d,e that are accessed by customers via a network 17 such as the Internet. Applications 12a,b,c depend on other servers 13a,b,c and their respective applications 14a,b,c, in order to function in their intended manner. For example, application 12a is a business application, application 12b is a web application and application 12c is a middleware application, and they require access to databases 15a,b,c managed by applications 13a,b,c on servers 14a,b,c, respectively. Consequently, if databases 15a,b,c, applications 14a,b,c, servers 13a,b,c or links 16a,b,c between servers 11a,b,c to servers 13a,b,c, respectively, fail, then applications 12a,b,c will be unable to function in a useful manner and may appear to the customer as “down” o “slow”, even though there are no defects inherent to applications 12a,b,c. Storage devices 17a,b,c contain databases 15a,b,c, respectively, and can be internal or external to servers 13a,b,c. The database manager applications 14a,b,c can be IBM DB2 database managers, Oracle database managers, Sybase database managers, MSSQL database managers, as examples. End user simulated probes may also reside in servers 11a,b,c,d,e and 13a,b,c or on the inter/intranet and send notifications of events indicative of failures of applications 12a,b,c,d,e, applications 14a,b,c or databases 15a,b,c to the event management console. The specific functions of the software applications 12a,b,c,d,e are not important to the present invention. Each of the servers 11a,b,c,d,e includes a known CPU 111, RAM 112, ROM 113, disk storage 115, operating system 114, and network interface card (such as a TCP/IP adapter card). Each of the servers 13a,b,c includes a known CPU 131, RAM 132, ROM 133, disk storage 135, operating system 134, and network interface card (such a s a TCP/IP adapter card). In an alternate embodiment of the present invention, applications 14a,b,c, monitor programs 35a,b,c and databases 15a,b,c reside on servers 11a,b,c, respectively; servers 13a,b,c are not provided.

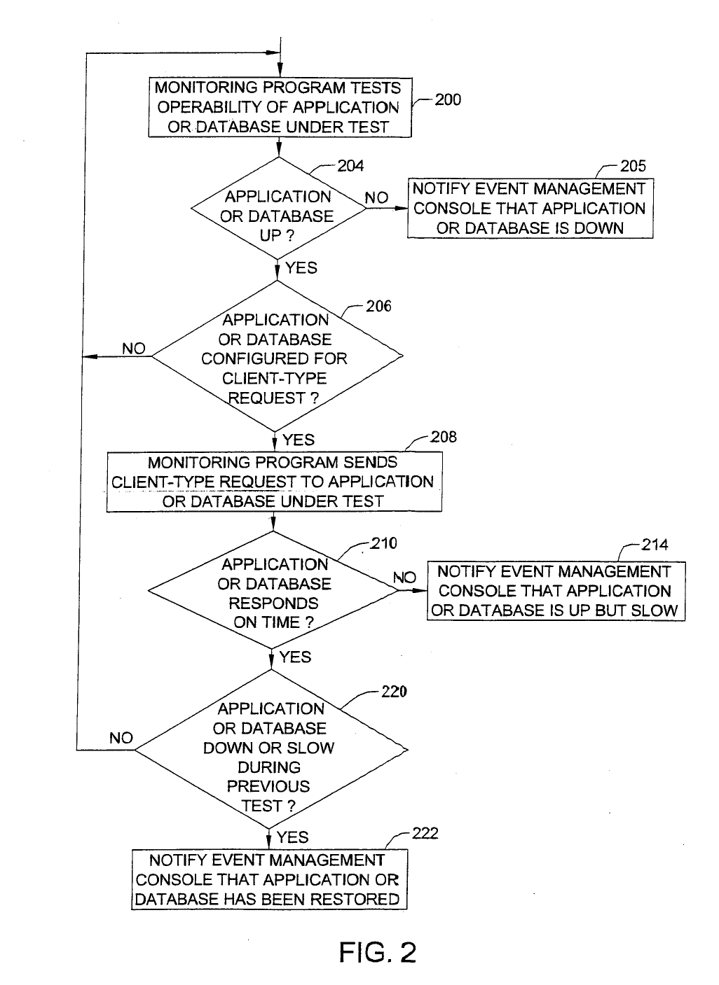

Known software monitoring agent programs 34a,b,c,d,e are installed on servers 11a,b,c,d,e, respectively to automatically monitor operability and in some cases, response time of applications 12a,b,c,d,e, respectively (i.e. stored in the respective computer readable storage 115 for execution by CPU 111 via computer readable RAM 112). Known software and database monitoring programs 35a,b,c are installed on servers 13a,b,c (i.e. stored in the respective computer readable storage 135 for execution by CPU 131 via computer readable RAM 132) to automatically monitor operability and response time of applications 14a,b,c and databases 15a,b,c. FIG. 2 illustrates the function of software monitoring programs 34a,b,c,d,e and software and database monitoring programs 35a,b,c. Software monitoring programs 34a,b,c,d,e and software and database monitoring programs 35a,b,c test operation of applications 12a,b,c,d,e and applications 14a,b,c by periodically “polling” processes running the applications 12a,b,c,d,e and database manager applications 14a,b,c (step 200 of FIG. 2). Software and database monitoring programs 35a,b,c test operability of databases 15a,b,c by checking if respective database processes are running, or by executing script (such as SQL) programs to attempt to read from or write to the databases 15a,b,c (step 200). (Monitoring programs 34a,b,c,d,e and 35a,b,c perform a type of monitoring based on a type of availability specified in the SLA.) If monitoring programs 34a,b,c,d,e or 35a,b,c do not receive a response indicative of the respective program or database operating, then the respective monitoring program 34a,b,c,d,e or 35a,b,c concludes that the respective application or database is down (decision 204, no branch), then the respective software monitoring program notifies an event management console 50 that the application or database is down or unavailable (step 205). The notification includes the name of the application or database that is down, the name of the server on which the down application or database is installed and the time it was detected that the application or database was down. If the application 12a,b,c,d,e or 14a,b,c or database 15a,b,c is not operating, this is likely due to an inherent problem with the application 12a,b,c,d,e or 14a,b,c or database 15a,b,c. If the monitoring program receives a response to the ping that the application or database is operational (decision 204, yes branch), then the monitoring program may simulate a client request (or invoke a related monitoring program to simulate the client request) for a function performed by the application 12a,b,c,d,e or 14a,b,c or database 15a,b,c, and measure the response time of the application 12a,b,c,d,e or 14a,b,c or database 15a,b,c (step 208). Next, the monitoring program determines if the application or database has responded within a predetermined, short enough time to indicate a functional state of the application (decision 210). If so, then the respective application or database is deemed to be operational, and no notification is sent to the event management console (decision 220, no branch) (unless the application or database was down or slow to respond during the previous test and has just been restored, as described below with reference to decision 220, yes branch). Refer again to decision 210 no branch, where the application or database has not responded in time, then the respective software monitoring program notifies the event management console 50 that the application or database is not functional or not performing as specified in the SLA. This condition can also be considered technically operational or “up” but “slow” (step 214). (Event management console 50 includes a known CPU 501, RAM 502, ROM 503, disk storage 505, operating system 504, and network interface card such as a TCP/IP adapter card). The notification also includes the identity of the application 12a,b,c,d,e or 14a,b,c or database 15a,b,c that failed, the identity of the server 11a,b,c,d,e or 13a,b,c on which the failed application or database is installed or accessed, and the date/time the failure was detected. If the application 12a,b,c,d,e is operating but slow to respond, this may be due to an inherent problem with the respective application 12a,b,c,d,e or a problem with another component upon which the respective application 12a,b,c,d,e depends such as a database 15a,b,c, a database manager application 14a,b,c or the server 13a,b,c on which the database manager application executes. For example, if application 12a cannot access requisite data from database 15a, then application 12a will appear to the monitoring program 34a as either “operational but slow” or “down”, depending on the type of response that the monitoring program 34a receives to its pings and simulated client requests to application 12a. If the application 14a,b,c is operating but slow to respond, this may be due to an inherent problem with the application 14a,b,c, or a problem with server 13a,b,c or database 15a,b,c (or a connection to database 15a,b,c if database 15a,b,c is external to server 13a,b,c). For example, if application 14a cannot access requisite data from database 15a, then application 14a will appear to the monitoring program 35a as either “operational but slow” or “down”, depending on the type of response that the monitoring program 35a receives to its pings and simulated client requests to application 14a and database 15a.

In one embodiment of the present invention, only complete inoperability of an application or database is considered a “failure” to be measured against the availability requirements of the SLA. In another embodiment of the present invention, both complete inoperability and slow operability (with a response time slower than a specified time in the SLA for the respective application or database) are considered a “failure” to be measured against the availability requirements of the SLA. However, when the failure is due to a (“dependency”) hardware or software component for which the service provider is not responsible for maintenance/operability, then the failure is not “charged” to the service provider and therefore, not counted against the service provider's commitment under the applicable SLA.

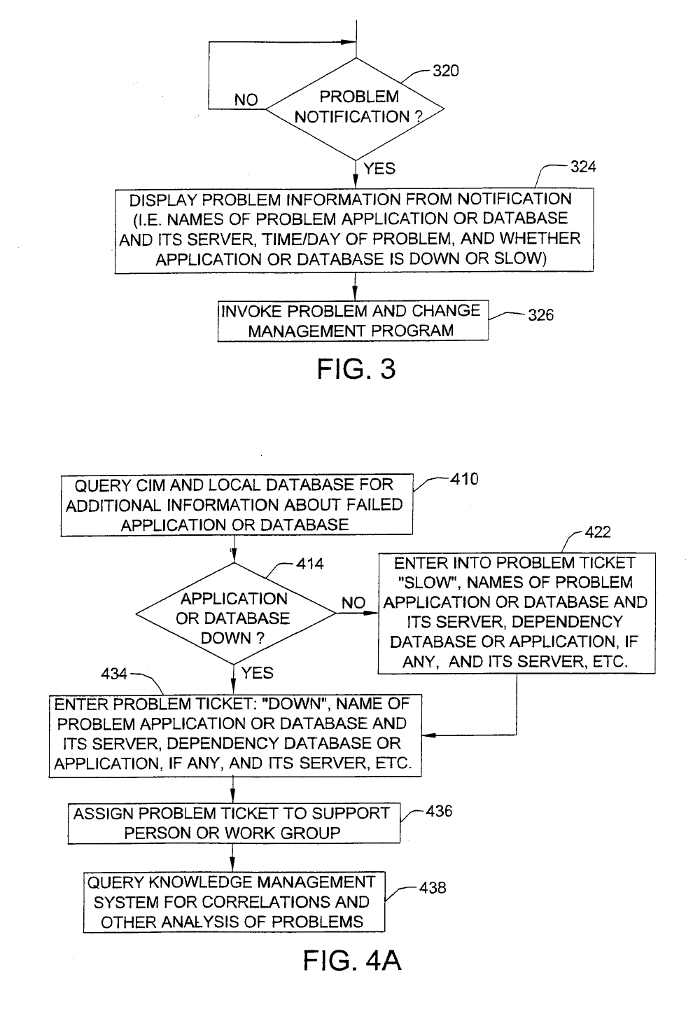

FIG. 3 illustrates the function of an event management program 52 within the event management console 50. Event management program 52 is stored in computer readable storage 505 for execution by CPU 501 via computer readable RAM 502. In response to the notification of the problem from the software monitoring program tool 34a,b,c,d,e or 35a,b,c (decision 320, yes branch), the event management console 50 displays the information from the notification so that a problem ticket can be generated (step 324). In one embodiment of the present invention, in response to the notification of the problem, the event management program 52 may invoke a known program function to integrate and automatically create the problem ticket. Program 52 automatically creates the problem ticket by invoking the problem and change management program 55, and supplying information provided in the notification from the monitoring program and additional information retrieved from a local database 52 and a configuration information management repository 56, as described below (step 326). In another embodiment of the present invention, in response to the display of the problem, an operator invokes the problem and change management program 55 to create a user interface and template to generate the problem ticket based on information provided in the notification from the monitoring program and additional information retrieved from local database 52 and configuration information management repository 56 (step 326).

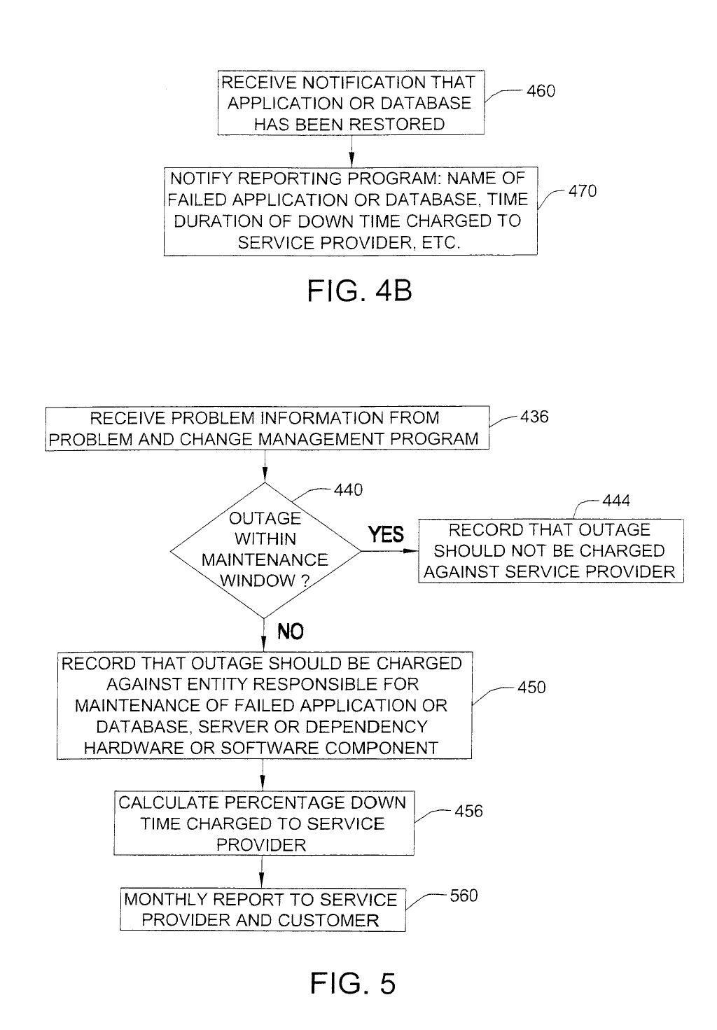

FIGS. 4(A) and (B) illustrate in more detail the function of problem and change management program 55 in computer 54. (Computer 54 includes a known CPU 151, RAM 152, ROM 153, disk storage 155, operating system 154, and network interface card such as a TCP/IP adapter card). Problem and change management program 55 is stored in computer readable storage 155 for execution by CPU 151 via computer readable RAM 152. Based on the name of the application or database that failed, and its server provided in the notification from the software monitoring program 34a,b,c,d,e or 35a,b,c, program 55 obtains the following (“granular”) information from configuration information management repository 56 (step 410):

(a) “Resource ID” of the failed application 34a,b,c,d,e or 35a,b,c.

(b) Identity of any “dependency” application (such as application 13a,b,c), server (such as server 14a,b,c) or database (such as databases 15a,b,c) upon which the failed application 12a,b,c,d,e or 14a,b,c depends. (The configuration information management repository 56 obtained this information either from an operator during a previous data entry process, or by fetching configuration tables of the applications 12a,b,c,d,e and 14a,b,c or databases 15a,b,c to determine what other applications or databases they query for data or other support function. The dependency information is preferably stored in a hierarchical manner, for example, server-subsystem-instance-database. This facilitates determination of compliance with the SLA at various component levels.

(c) criticalities of applications 12a,b,c,d,e and 14a,b,c and database 15a,b,c. This is used to determine the service provider's “grace period” for fixing any problem without the outage being charged against the service provider under the SLA. Generally, the “grace period” for fixing a problem with a critical database is shorter than the “grace period” for fixing a problem with a noncritical database.

(d) Times/dates of scheduled (i.e. “normal”) outages or “maintenance windows” for the servers 11a,b,c,d,e, applications 12a,b,c,d,e, servers 13a,b,c, applications 14a,b,c and databases 15a,b,c.

Based on the name of the failed application provided in the problem notification, and the name(s) of the failed application's dependency application(s), server(s) and database(s) read from the CIM program (or data managers, not shown, in problem and change management system 56), program 55 obtains from a local database 52 (step 410):

(A) Name of service person or workgroup (of service people) responsible for maintenance of the failed application 12a,b,c,d,e or 14a,b,c or database 15a,b,c.

(B) Name of service person or workgroup responsible for maintenance of the server on which the failed application or database is installed.

(C) Name of service person or workgroup responsible for maintenance of any dependency application or database.

(D) Name of service person or workgroup responsible for maintenance of the server on which any dependency application or database is installed.

(E) Name of service person or workgroup responsible for maintenance of any other dependency hardware, software or database component.

(In the illustrated example, repository 56 resides on computer 58 which also includes a CPU, RAM, ROM, disk storage, TCP/IP adapter card and operating system. It should be noted that the division of the foregoing information between the configuration information management repository 56 with its remote database and the local database 52 is not important to the present invention. If desired, all the foregoing information can be maintained in a single database, either local or remote, or spread across additional supporting infrastructure databases.)

The problem and change management program 55 may automatically insert into the problem ticket all of the foregoing information (to the extent applicable to the current problem), as well as the names of the failed application or database and server on which the failed application or database is installed, the time/date when the failure was detected, and the nature of the failure. Alternatively, the operator retrieves this information from the event management console and uses the information to update required fields during the problem ticket creation process. Thus, if the failed application or database is operational but slower than permitted in the SLA (decision 414, no branch), then the problem and change management program includes in the problem ticket an indication of unacceptably slow operation or operational but not functional condition (step 422). If the application or database is not operational at all (decision 414, yes branch), then the problem and change management program includes in the problem ticket an indication that the application or database is down (step 434). Also in steps 422 and 434, the operator can override any of the information automatically entered by the problem and change management program based on other, extrinsic information known to the operator.

Next, the operator of program 55 decides to whom to assign the problem ticket, i.e. who should attempt to correct the problem. Typically, the operator will assign the problem ticket to the support person or work group responsible for maintaining the application, database or hardware or software dependency component that failed, as indicated by the information from the local database 52 (step 436). However, occasionally the operator will assign the problem ticket to someone else based on the type of application 12a,b,c,d,e or 14a,b,c or database 15a,b,c experiencing the problem, a likely cause of the problem, or possibly information provided by a knowledge management program 70, as described below.

Distributed computer system 10 optionally includes knowledge management program 70 (including a database) on a knowledge management computer 76 to provide information for the operators on each of the problem notifications from the monitoring programs 34a,b,c,d,e and 35a,b,c (step 438). Program 70 includes cause and effect rules corresponding to some of the situations described by problem notifications so that the operator may identify patterns of failure, such as a same type of failure reoccurring at approximately the same time/day each week or month. This could indicate an overload problem at a peak utilization time each week or month. If the operator identifies any patterns to the current problem in program 70, then the operator can update the problem ticket as to the possible root cause. The operator can use this information to determine to whom to assign the problem ticket and also enter this information into the problem ticket to assist the service person in correcting the problem and avoiding reoccurrence of the same problem in the future. For example, if there is an overload problem at a peak utilization time/day each week or month, then the service person may need to commission another server with the same application or database to share the workload during that time/day.

System 10 also includes a reporting management program 60 which can reside on a computer 66 (as illustrated) or on computer 54. (Computer 66 includes a known CPU, RAM, ROM, disk storage, operating system, and network interface card such as a TCP/IP adapter card.) The problem and change management program 55 sends problem ticket information (individually or compiled) to the reporting program 60 (step 436) which evaluates information in the problem ticket including the scheduled/maintenance windows. In the case where the application or database is either down or unacceptably slow, the reporting program 60 system calculates whether the application or database was down or unacceptably slow during a scheduled/normal maintenance window of the application or database or any hardware or software dependency component. The reporting program 60 also determines and/or applies criticality of the failed resource and outage duration (decision 440). If the application or database was down during a scheduled/maintenance window (decision 440, yes branch), this is considered “normal” and not due to a failure of the application or database or fault of anyone. Consequently, the reporting program 60 makes a record that this failure should not be charged against (or attributed to) the service provider or the customer (step 444). Conversely, if the failure did not occur during a scheduled maintenance window of the application or database or any hardware or software dependency component (decision 440, no branch) (and did not occur during any other outage or exception approved by the customer), the reporting program 60 makes a record that this outage should be charged against (or attributed to) the entity responsible for maintenance of the failed application or database, or any failed hardware or software dependency component (step 450).

Some time after the problem ticket is “opened”, a support person corrects the problem so that the failed application or database is restored, i.e. returned to the complete operational state. The monitoring program 34a,b,c,d,e or 35a,b,c will continue to check the operational state of the previously failed application 12a,b,c,d,e or 14a,b,c or database 15a,b,c by (i) pinging them and checking for a response to the ping, and (ii) simulating client-type requests, if the monitoring program is so programmed, and checking for timely responses to the client-type requests (steps 200, 204 yes branch, 206, 208, and 210 yes branch). Because the application or database was down or unacceptably slow during the previous test (decision 220, yes branch), the monitoring program will notify the event management program 52 at its next polling time, that the application has been restored (step 222). In response, the event management program 52 may notify the problem and change management program 55 that the application or database has been restored and the time/date when the restoration occurred. Alternately, the support person specifically reports to the problem and change management program 55 the time/date that the failed application or database was restored or this is inferred from the time/date of “closure” of the problem ticket. In addition, the support person enters information into the problem ticket indicating the actual cause of the problem as determined during the correction process, i.e. what application, database, server or other computer, database or communications component actually caused application 12a,b,c,d,e or 14a,b,c or database 15a,b,c to fail or be slow, the outage duration, who was responsible for the problem (customer vs. service provider) and the actual reason for the failure. In either scenario, in step 460, the problem and change management program 55 receives notification of the restoration of the previously failed application, and updates the respective problem ticket accordingly.

Periodically, the reporting program 60 collects from the problem and change management program 55 information describing (a) the duration of the failure of application 12a,b,c,d,e or 14a,b,c or database 15a,b,c, (b) whether a dependency hardware or software component caused application 12a,b,c,d,e or 14a,b,c or database 15a,b,c to fail or be slow, (c) the entity responsible for maintaining the failed application 12a,b,c,d,e or 14a,b,c or database 15a,b,c, the entity responsible for maintaining any dependency hardware or software component that caused application 12a,b,c,d,e or 14a,b,c or database 15a,b,c to fail or be slow, (d) whether the failure of application 12a,b,c,d,e or 14a,b,c or database 15a,b,c was caused by a scheduled or customer authorized outage of application 12a,b,c,d,e or 14a,b,c or database 15a,b,c, server 11a,b,c,d,e or 13a,b,c or other dependency hardware or software component that caused application 12a,b,c,d,e or 14a,b,c or database 15a,b,c to fail or be unacceptably slow (step 470). Some SLAs give the service provider a specified “grace” time to fix each problem or each of a certain number of problems each month without being “charged” for the failure. Typically, the “grace period” (if applicable) is based on the criticality of the application or database; a shorter grace period is allowed for the more critical applications and databases. When applicable, this “grace period” is recorded in the remote database of CIM repository 56 or within problem management computer 54. The reporting program 60 fetches this “grace period” information in step 410. The reporting program 60 then subtracts the applicable grace period from the duration of each outage and charges only the difference, if any, to the service provider for purposes of determining down time and compliance with the SLA.

Periodically, such as monthly, the reporting program 60 processes the failure information supplied by program 55 during the reporting period to determine whether the service provider complied with the SLA for the application or database, and then displays reports for the service provider and customer (step 560 of FIG. 5). As explained in more detail below, reporting program 60 calculates and includes in the report the percent down time of each of the applications 12a,b,c,d,e and 14a,b,c and databases 15a,b,c which is the fault of the service provider. Thus, the program 60 does not count against the service provider any down or slow time of applications 12a,b,c,d,e or 14a,b,c or database 15a,b,c (i) caused, directly or indirectly, by an application, database, server or other dependency software or hardware component for which the customer or any third party is responsible for maintenance, (ii) which occurred during a scheduled maintenance window or customer approved outage, or (iii) for which a “grace period” applied. For example, if application 12a was unacceptably slow or down due to an outage of dependency application 14a, the outage of application 12a and application 14a did not occur during a scheduled maintenance window, and the customer was responsible for maintaining application 14a, then the unacceptably slow operation or inoperability of application 12a would not be charged to the service provider. As another example, if application 12a was unacceptably slow or down due to an outage of dependency database 15a, the outage of application 12a and database 15a did not occur during a scheduled maintenance window, and the customer was responsible for maintaining database 15a, then the slow operation or inoperability of application 12a would not be charged to the service provider. As another example, if application 12a was down due to a failure of server 11a, the outage did not occur during a scheduled maintenance window of application 12a or 11a or other customer approved outage, and the customer is responsible for maintaining server 11a, then the failure of application 12a would not be charged to the service provider.

The formula for calculating the percent down time or unacceptably slow response time attributable to the service provider is based on the following:

(a) Expected Total Number of minutes of availability each month=total minutes in month that application or database is expected to fully function as specified in the SLA minus duration of scheduled maintenance windows as specified in the SLA minus duration of customer approved outages (for example, to install new software or updates at a time other than scheduled maintenance window).

(b) Number of Down Time or Unacceptably Slow Operation minutes attributable to service provider (as determined above in FIG. 4(A) and (B)).

(c) Percent Failure charged to service provider=Number of Down Time or Unacceptably Slow Operation minutes divided by Expected Total Number of minutes.

The reporting program 60 also calculates the business impact/cost due to the downtime caused by the service provider, in excess of the down time permitted in the SLA. The reporting program 60 obtains from the configuration information management repository 56 a quantification of the respective impact/cost (per unit of down time) to the customer's business caused by the failure of the application 12a,b,c,d,e or 14a,b,c or database 15a,b,c. The unit impact/cost typically varies for each type of application or database. Then, the reporting program 60 multiplies the respective impact/cost (per unit of down time) by the down time charged to the service provider for each application 12a,b,c,d,e and 14a,b,c or database 15a,b,c in excess of the down time permitted in the SLA to determine the total impact/cost charged to the service provider. Then, the reporting program 60 presents to the service provider and customer the outage information including (a) the total down time of each of the applications 12a,b,c,d,e and 14a,b,c or database 15a,b,c, (b) the percent down time of each of the applications or databases attributable to either the customer or the service provider, (d) the percent down time of each of the applications 12a,b,c,d,e and 14a,b,c or database 15a,b,c attributable only to the service provider, and (e) the total business impact/cost of the failure of each application or database due to the fault of the service provider in excess of the outage amount allowed in the SLA.

Each of the programs 52, 55, 56, 60 and 70 can be loaded into the respective computer from a computer storage medium such as a magnetic tape or disk, CD, DVD, etc. or downloaded from the Internet via a TCP/IP adapter card.

Based on the foregoing, a system, method and computer program for determining compliance of a computer program or database with a service level agreement have been disclosed. However, numerous modifications and substitutions can be made without deviating from the scope of the present invention. Therefore, the present invention has been disclosed by way of illustration and not limitation, and reference should be made to the following claims to determine the scope of the present invention.

1. A method for monitoring a first computer program in a first server maintained by a service provider for a customer to determine compliance by the service provider with service level criteria, the method comprising the steps of:
a computer determining that (a) the first computer program depends on a second computer program in a second server for information to function normally, (b) a first failure of the first computer program was due to a failure of the second computer program, and (c) the service provider was not responsible for maintenance of the second computer program at a time of the first failure; and
the computer determining that a second failure of the first computer program was due to failure of the first computer program and/or first server not to failure of the second computer program; and
the computer determining, in part, whether the service provider complied with the service level criteria by charging the service provider with the second failure but not charging the service provider with the first failure.

2. The method of claim 1 wherein the second computer program is a database management program, and the information is data from a database managed by the database management program.

3. The method of claim 1 wherein the step of the computer determining that the first computer program depends on the second computer program in the second server for information to function normally and the service provider was not responsible for maintenance of the second computer program at the time of the first failure comprises the step of the computer querying a database(s) for information indicating whether (a) the first computer program depends on the second computer program for information to function normally and (b) the service provider was responsible for maintenance of the second computer program.

4. The method of claim 1 wherein the compliance determining step comprises the step of the computer calculating a percent time during an interval that the first computer program had failed based in part on respective durations of the first and second failures.

5. The method of claim 1 wherein the first failure was a slow-performance failure of the first computer program while the first computer program was operational.

6. The method of claim 1 wherein the first failure was a slow-performance failure of the first computer program while the first computer program was operational, and the failure of the second computer program was a slow-performance failure of the second computer program while the second computer program was operational.

7. A computer system for monitoring a first computer program in a first server maintained by a service provider for a customer to determine compliance by the service provider with service level criteria, the computer system comprising:
a CPU, a computer readable memory and a computer readable storage media;
first program instructions to determine if (a) the first computer program depends on a second computer program in a second server for information to function normally, (b) a first failure of the first computer program was due to a failure of the second computer program, and (c) the service provider was responsible for maintenance of the second computer program at a time of the first failure; and
second program instructions to determine if a second failure of the first computer program was due to failure of the first computer program and/or first server not to failure of the second computer program; and
third program instructions to determine, in part, whether the service provider complied with the service level criteria by charging the service provider with the second failure but not charging the service provider with the first failure; and wherein
the first, second and third program instructions are stored on the computer readable storage media for execution by the CPU via the computer readable memory.

8. The computer system of claim 7 wherein the second computer program is a database management program, and the information is data from a database managed by the database management program.

9. The computer system of claim 7 wherein the first program instructions determine if the first computer program depends on the second computer program for information to function normally and the service provider was responsible for maintenance of the second computer program at the time of the first failure by querying a database(s) for information indicating whether the first computer program depends on the second computer program for information to function normally and whether the service provider was responsible for maintenance of the second computer program.

10. The computer system of claim 7 wherein the third program instructions determine compliance by calculating a percent time during an interval that the first computer program had failed based in part on respective durations of the first and second failures.

11. The computer system of claim 7 wherein the first failure was a slow-performance failure of the first computer program while the first computer program was operational.

12. The computer system of claim 7 wherein the first failure was a slow-performance failure of the first computer program while the first computer program was operational, and the failure of the second computer program was a slow-performance failure of the second computer program while the second computer program was operational.

13. A computer program product for monitoring a first computer program in a first server maintained by a service provider for a customer to determine compliance by the service provider with service level criteria, the computer program product comprising:
a CPU, a computer readable memory and a computer readable storage media;
first program instructions to determine if (a) the first computer program depends on a second computer program in a second server for information to function normally, (b) a first failure of the first computer program was due to a failure of the second computer program, and (c) the service provider was responsible for maintenance of the second computer program at a time of the first failure; and
second program instructions to determine if a second failure of the first computer program was due to failure of the first computer program and/or first server not to failure of the second computer program; and
third program instructions to determine, in part, whether the service provider complied with the service level criteria by charging the service provider with the second failure but not charging the service provider with the first failure; and wherein
the first, second and third program instructions are stored on the computer readable storage media.

14. The computer program product of claim 13 wherein the second computer program is a database management program, and the information is data from a database managed by the database management program.

15. The computer program product of claim 13 wherein the first program instructions determine if the first computer program depends on the second computer program for information to function normally and the service provider was responsible for maintenance of the second computer program at the time of the first failure by querying a database(s) for information indicating whether the first computer program depends on the second computer program for information to function normally and whether the service provider was responsible for maintenance of the second computer program.

16. The computer program product of claim 13 wherein the third program instructions determine compliance by calculating a percent time during an interval that the first computer program had failed based in part on respective durations of the first and second failures.

17. The computer program product of claim 13 wherein the first failure was a slow-performance failure of the first computer program while the first computer program was operational.

18. The computer program product of claim 14 wherein the first failure was a slow-performance failure of the first computer program while the first computer program was operational, and the failure of the second computer program was a slow-performance failure of the second computer program while the second computer program was operational.
